(19) United States
(12) Patent Application Publication
(10) Pub. No.: US 2012/0245846 A1
(43) Pub. Date: Sep. 27, 2012

(54) PORTABLE EQUIPMENT

(76) Inventors: SHINICHI YOSHIDA, Tama-ku (JP); MAKOTO ITO, Toda-shi (JP); FUMIKI NAKAMURA, Yokohama-shi (JP)

(21) Appl. No.: 13/417,523

(22) Filed: Mar. 12, 2012

(30) Foreign Application Priority Data
Mar. 22, 2011 (JP) 2011-062229

(51) Int. Cl. G01C 21/00

(52) U.S. Cl. 701/526

(57) ABSTRACT

Portable device, like a digital camera, is equipped with a GPS receiver, thereby detecting a current position. When a change does not occur in the detected current position for a given period of time or more, the position is considered to be a living sphere, like a user's home. When the user is situated in the living sphere, a receive cycle of the GPS receiver is increased so as to become larger than a normal receive cycle, thereby reducing power consumption.

### CROSS REFERENCE TO RELATED APPLICATIONS

This application claims priority to Japanese Patent Application No. 2011-62229, filed on Mar. 22, 2011, which is incorporated herein by reference in its entirety.

### FIELD OF THE INVENTION

The present invention relates to portable equipment and, more particularly, to portable equipment with a position detection function.

### BACKGROUND OF THE INVENTION

Portable equipments capable of detecting locations thereof by utilization of a GPS and the like, such as portable phones and digital cameras, have hitherto been developed.

With a view toward providing a positioning unit capable of reducing wasteful power consumption and performing GPS positioning processing at appropriate intervals even when a change has occurred in travel speed in the course of use of the positioning unit, 2010-38799A describes travel speed detection means that detects a travel speed of a positioning unit at a positioning location, determination means that determines whether or not the travel speed detected by the travel speed detection means is a predetermined speed or less, and intermittent activation means that intermittently activates positioning means when the determination means has determined that the travel speed is a predetermined value or less.

From the viewpoint of reduction of power consumption, it is effective to intermittently activate the positioning unit when a travel speed is a predetermined speed or less. In the meantime, when the travel speed is the predetermined speed or more, the positioning unit operates at normal intervals without exception, so that the effect of reducing power consumption is limited. Specifically, in a district very familiar to the user and elsewhere, high precision positioning is conceived to be not necessarily required without regard to a travel speed. However, the positioning unit has a problem of performing high precision positioning operation at all times, to thus consume power.

### SUMMARY

The present invention aims at providing portable equipment capable of reducing wasteful power consumption to a much greater extent by reducing power consumption of a positioning unit under circumstances where high precision positioning is conceived to be not necessarily required for the user.

Accordingly, the present invention is directed toward portable equipment comprising: positional data detection means; registration means for registering positional data pertaining to a user's living sphere; and control means that relatively increases a position detection interval of the positional data detection means when detected positional data correspond to the positional data pertaining to the living sphere than when the detected positional data do not correspond to the positional data pertaining to the living sphere.

In one embodiment of the present invention, the living sphere is a neighborhood of a position where a user stays for a given period of time or more.

In another embodiment of the present invention, the living sphere is a neighborhood of a user's home.

In still another embodiment of the present invention, when a change does not occur in the detected positional data for a given period of time or more, the registration means automatically registers the positional data as positional data pertaining to the living sphere.

In yet another embodiment of the present invention, when the detected positional data correspond to the positional data pertaining to the living sphere, the control means sequentially increases the position detection interval according to a sojourn time.

The present invention makes it possible to reduce power consumption of positional data detection means (a positioning device) to a much greater extent.

The invention will be more clearly comprehended by reference to the embodiments provided below. However, the scope of the invention is not limited to the embodiments.

### BRIEF DESCRIPTION OF THE DRAWINGS

A preferred embodiment of the present invention will be described in detail by reference to the following drawings, wherein:

FIG. 1 is a block diagram of a digital camera of an embodiment of the present invention; and

FIG. 2 is a processing flowchart of the embodiment.

### DETAILED DESCRIPTION OF THE INVENTION

Referring to the drawings, an embodiment of the present invention is hereunder described by means of taking a digital camera as an example of portable equipment. The embodiment provided below is a mere illustration, and the present invention is not limited to the embodiment provided below.

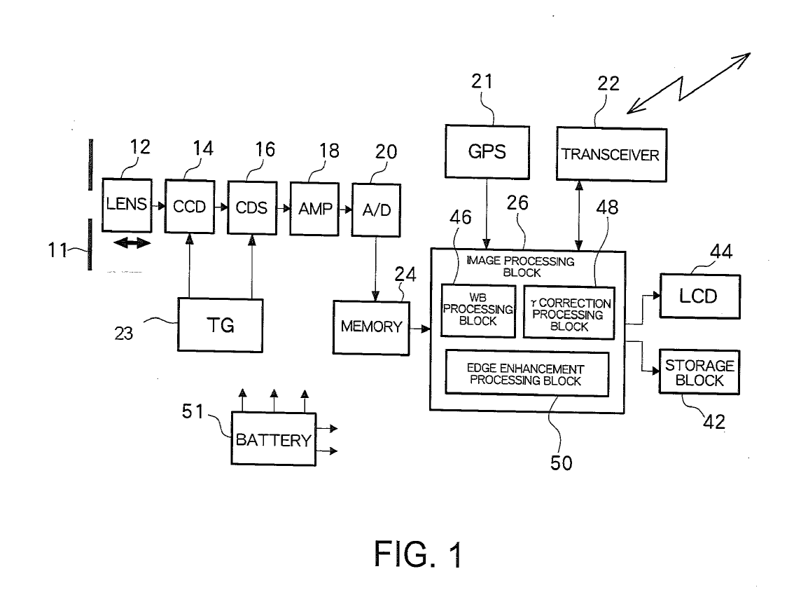

FIG. 1 shows a block diagram of the digital camera of the embodiment. Field light input by way of a diaphragm 11 and a lens 12 comes into a focus on a CCD 14 that is an imaging device. A CPU controls an F-number of the diaphragm 11 and a travel distance of the lens 12. The CCD 14 converts the thus-input field light into an electric signal and outputs the electric signal. The CPU controls timing at which the CCD 14 performs photoelectric conversion by way of a timing generator (TG) 22. In order to acquire a preview image to be displayed on an LCD 44, the CCD 14 accumulates and discharges electric charges at given intervals at all times. When a “take picture” command is received from a user, photoelectric conversion intended for acquiring a preview image is temporarily interrupted. Electric charges are accumulated during an exposure time which would originally be required to photograph an image. The thus-accumulated electric charges are subsequently read out. A CMOS can also be used in place of the CCD 14.

The electric signal output from the CCD 14 undergoes predetermined analogue signal processing performed by a correlated double sampling circuit (CDS) 16 and amplification processing performed by an amplifying circuit (AMP) 18 and is subsequently converted into digital data by an A-D converter (A/D) 20. Digital data produced through conversion are temporarily stored in memory 24 as image data and fed to an image processing block 26.

The image processing block 26 consists of a microprocessor and has a white balance (WB) processing block 46, a γ correction processing block 48, an edge enhancement processing block 50, and a compression-expansion processing block, and others. The image processing block 26 processes the image data temporarily stored in the memory 24 with known image processing. The image data processed with required processing in the image processing block 26 are compressed in a JPEG format, and the like, and subsequently saved in storage block 42. When a command to reproduce the image data saved in the storage block 42 is received from the user, the image processing block 26 processes the image data read from the storage block 42 with expansion processing and displays the thus-expanded image data on the LCD 44.

A GPS receiver 21 serving as a position detecting device receives a GPS radio wave from GPS satellites and outputs the thus-received GPS data to the image processing block 26. The image processing block 26 acquires latitude-longitude data from the GPS data; adds the latitude-longitude data to image data; and saves the thus-acquired latitude-longitude data into the storage block 42. For instance, the image processing block 26 records image data along with latitude-longitude data acquired from GPS data by utilization of a tag conforming to an Exif (Exchangeable image file format for digital still cameras) standard.

Pursuant to the command from the user, the image processing block 26 reads the image data saved in the storage block 42 and transmits (uploads) the thus-read data to a server on the Internet by use of a radio transceiver 22. As a matter of course, pursuant to a command from the user, the image processing block 26 can also receive (download) arbitrary image data from the server on the Internet by use of the radio transceiver 22.

Respective blocks of the digital camera operate by receipt of electric power fed by a built-in battery 51. The built-in battery 51 is; for instance, a lithium ion battery that can be connected to an external power source by way of an AC adaptor, to thus be charged.

With such a configuration, the image processing block 26 serving as a microprocessor controls activation/deactivation of a power source of the GPS receiver 21 and a position detecting interval of the GPS receiver 21, thereby reducing power consumption of the built-in battery 51. Controlling a position detecting interval is specifically carried out by controlling an interval between operations of the GPS receiver 21 for receiving GPS signal. Further, when positions that can be deemed to fall within a user's living sphere are automatically registered and when a position detected by the GPS receiver 21 falls within the user's living sphere, a receive interval of the GPS receiver 21 can be increased as compared with a normal receive interval. The user's living sphere means a neighborhood of the user's house, a neighborhood of the user's work place, and so on; namely, locations that can be deemed to be a geographical area well familiar to the user. When the user is situated in the living sphere, high precision position detection is considered to be not necessarily required. Therefore, an increase in receive interval of the GPS receiver 21 does not raise any problems, so that the electric power consumed by the GPS receiver 21 can be reduced.

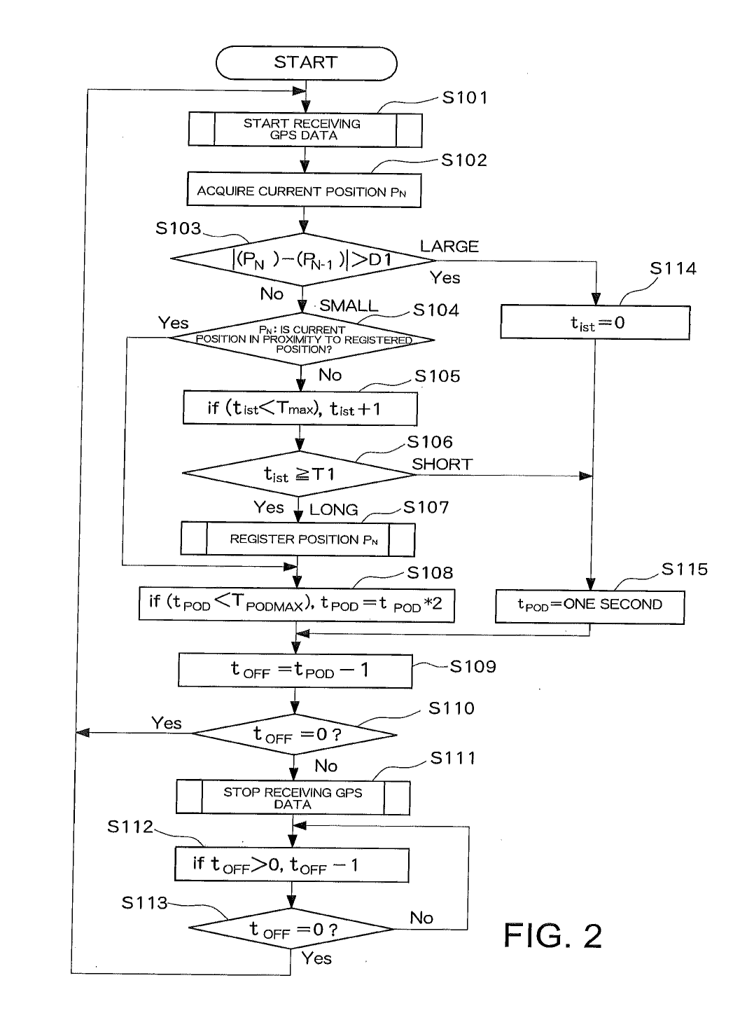

FIG. 2 is a processing flowchart of the embodiment. First, the image processing block 26 serving as a microprocessor activates the GPS receiver 21, thereby commencing receipt of GPS data (S101). A current position P_{N} of (latitude-longitude data pertaining to) the digital camera is acquired from the received GPS data (S102). The thus-acquired position P_{N} is sequentially stored in memory of the image processing block 26.

Next, the current position P_{N} and a previously acquired position P_{N-1} are read from the memory, respectively, and the thus-read positions are compared to each other, thereby determining whether or not a difference is greater than a distance D1 (S103). This is carried out for determining whether or not the user of the digital camera still stays at a certain position. Although the threshold distance D1 can be arbitrarily set, the distance is set to; for instance, 200 m.

When a difference between the current position P_{N} and the previous position P_{N-1} is smaller than the threshold distance D1, a determination is made as to whether or not the current position P_{N} is in proximity to a registered location (S104). The determination can also be made according to whether or not a difference between positional data pertaining to the current position P_{N} and positional data pertaining to the registered location falls within a predetermined distance. Although the predetermined distance can be arbitrarily set, the distance can be set to; for instance, 200 m. Attention must be paid to the fact that a difference exists between the threshold distance used in determination processing and the threshold distance used in S103 in terms of a technical significance. Specifically, the threshold distance used in S103 is a threshold for determining whether or not the user stays at a certain position, whereas the threshold distance used in S104 acts as a threshold value for specifying a user's living sphere.

When a registered position is not yet present, NO is selected in determination processing, whereby a parameter tᵢₛₜ showing a user's accumulated sojourn time is increased by increments of one second (S105). When the parameter tᵢₛₜ has reached a predetermined maximum value Tₘₐₓ, the parameter is held as it is at the maximum value Tₘₐₓ without performing increment processing.

After the user's accumulated sojourn time has been calculated by incrementing the parameter tᵢₛₜ, a determination is made as to whether or not the parameter tᵢₛₜ is a predetermined threshold time T1 or more (S106). When the parameter tᵢₛₜ is the predetermined threshold time T1 or more, the user stays at the current position P_{N} for a period of time sufficient to admit that the position is a part of the living sphere. Therefore, there is considered to be a high probability that the user is staying at a home or a workplace. The current position P_{N} is therefore newly registered in the memory of the image processing block 26 as positional data pertaining to the user's living sphere (S107). The positional data thus registered are data pertaining to a center position of the user's living sphere. The living sphere is specified to fall within a threshold distance centering on the positional data (the range specified by the threshold distance used in S104).

After having registered positional data pertaining to the living sphere, the image processing block 26 doubles a current parameter t_{POD} representing a receive interval of the GPS receiver 21 (S108). Specifically, the current parameter t_{POD} is newly updated to t_{POD}×2. When the parameter t_{POD} has already reached a predetermined maximum value T_{PODMAX}, the maximum value is maintained as it is without performing increment processing. For instance, when the maximum value is set to 10 minutes, the parameter t_{POD} is sequentially increased to 2 seconds, 4 seconds, 8 seconds, 16 seconds, 32 seconds, . . . , so long as the user stays at the current position P_{N}. At a point in time when the parameter t_{POD} has reached 10 minutes, the value is maintained.

In the meantime, the current position P_{N} and the previous position P_{N-1} are compared with each other in S103. When a difference is greater than the threshold distance D1, the user is considered to have moved, so that the parameter tᵢₛₜ is reset to zero (S114). Further, the parameter t_{POD} is also reset to one second that is a normal receive cycle (S115). When the user keeps moving, the parameter tᵢₛₜ is continually held at zero, and the parameter t_{POD} is also kept at one second.

When the parameter tᵢₛₜ is smaller than the predetermined threshold time T1 in S106, the value means that the user did not stay at that position for a period of time sufficient to consider the position as a living sphere. The position is determined not to be the user's living sphere, and the parameter t_{POD} is likewise reset to one second (S115).

Further, when in S104 the current position P_{N} is determined to be a neighborhood of a registered position; namely, when the current position is determined to fall within a predetermined threshold distance from a position represented by the registered positional data and also in a registered living sphere, the current parameter t_{POD} is doubled (S108).

After the parameter t_{POD} representing the receive interval of the GPS receiver 21 has been set, as mentioned above, to an ordinary value of one second or more according to whether or not the current position P_{N} falls within the living sphere, a parameter t_{off} for deactivating the GPS receiver 21 is computed from the parameter t_{POD}. Specifically, the parameter t_{off} is computed from t_{off}=t_{POD}−1 (S109). It is determined whether or not a value of the parameter t_{off} is zero (S110). When the value of the parameter t_{POD} is set to one second through processing pertaining to S115, the parameter t_{POD} is subtracted by one in S109, to thus come to zero. Therefore, YES is selected through determination processing, and processing subsequent to S101 is iterated, whereby the GPS receiver 21 continually receives the GPS data. Specifically, positioning is carried out at an interval of one second.

In contrast, when in S108 the parameter t_{POD} is set to a double value or more, the parameter t_{POD} will not come to zero even if one is subtracted from the parameter in step S109. Therefore, NO is selected through determination processing. The receiving operation of the GPS receiver 21 is then halted (S111), and one is subtracted from the parameter t_{off} (S112). The receiving operation of the GPS receiver 21 is kept halted until the parameter t_{off} comes to zero. Processing subsequent to S101 is then iterated, thereby resuming receiving operation of the GPS receiver 21 (S113). The parameter t_{off} is computed from the parameter t_{POD}. When the user is situated in the living sphere, the parameter t_{POD} successively increases. Therefore, a down time of the GPS receiver 21 correspondingly increases. In the end, the GPS receiver 21 receives GPS data at a receive cycle determined by the parameter t_{POD} and performs position detection.

Processing of the present embodiment is described more specifically.

It is now assumed that a user's living sphere is not registered in a digital camera and that the user is now operating the digital camera to take pictures at home. In this case, when NO is selected in S103 and also in S104, YES is selected in S106, whereby positional data pertaining to a home are registered as positional data pertaining to a living sphere into the memory of the image processing block 26.

In S108, a receive interval of the GPS receiver 21 is set to two seconds that is double the current receive interval, and receiving operation of the GPS receiver 21 is halted in S111. Subsequently, after elapse of a time corresponding to a duration of the receive interval, receiving and position detection of the GPS receiver 21 are resumed. When the user continually stays at home, YES is selected in S104. The receive interval of the GPS receiver 21 is set to a double value; namely, four seconds, and receiving operation of the GPS receiver 21 is halted in S111. After elapse of a time corresponding to a duration of the receive interval, receiving operation and position detection of the GPS receiver 21 are resumed. When the user stays at home, the receive interval of the GPS receiver 21 is sequentially doubled, quadrupled, and octupled. When reached the preset maximum value, the receive interval is not increased any more. The receiving and position detection of the GPS receiver 21 are performed at the maximum interval.

When the user has left the neighborhood of the home, YES is determined in S103, so that the receive interval of the GPS receiver 21 is set to a normal value of one second, whereby positioning is performed every one second.

When the user has left the home and does work at a workplace, NO is again selected in S103, and also NO is selected in S104. Positional data pertaining to the workplace are registered in memory as new positional data pertaining to the living sphere. As long as the user is situated at the workplace, the receive interval of the GPS receiver 21 is sequentially increased; namely, doubled and quadrupled. The GPS receiver 21 performs receiving and position detection at an increased receive interval.

As mentioned above, when the user stays in the living sphere, the receive interval of the GPS receiver 21 is automatically adjusted so as to become larger than the normal receive interval. Therefore, wasteful power consumption of the GPS receiver 21 can be reduced. Further, when the user has left the living sphere, the receive interval of the GPS receiver 21 automatically returns to its normal interval, so that the accuracy of positioning is maintained.

In the present embodiment, when the user of the digital camera stays at one position for a given period of time or more, the user is considered to stay in the living sphere, and the position is automatically registered. However, prior to automatic registration of the position, a message stating “Do you register a current position as a living sphere?” can also be displayed on the LCD 44, to thus prompt the user to perform ascertainment. When the user has performed ascertainment, the current position is registered.

In the present embodiment, the user can also be considered to stay in the living sphere not only when the user of the digital camera stays at one position for a given period of time or more but also when the user repeatedly stays at one position for a given period of time or more every day. In this case, the user's position will be monitored for at least several days, and a determination will be made as to whether or not a detected position lies in the living sphere according to data pertaining to results of monitoring operation performed for the several days.

Although the threshold time T1 can also be arbitrarily set, the time may also be made adjustable by the user. The reason for this is that, if the threshold time T1 is too short, a position where the user temporarily stays may be erroneously registered as the user's living sphere. Alternatively, processing pertaining to S106 may also be followed by additional processing; namely, processing for determining whether or not the parameter tᵢₛₜ showing an accumulated sojourn time is a second threshold time T2 (T2>T1) or more and registering the current position P_{N} only when the parameter tᵢₛₜ is T2 or more.

In the present embodiment, the user's living sphere is automatically registered. However, the user can also manually register his/her home and workplace in advance. In this case, a registration button is provided on the digital camera, and the current position P_{N} achieved at a point in time when the registration button is actuated is registered in memory as positional data pertaining to the living sphere. On this occasion, a threshold distance of the registered positional data is also registered simultaneously, whereby the user can manually register an extent of the living sphere defined by the positional data and the threshold distance. As a matter of course, the user can manually register the positional data, and the digital camera may set a default for a threshold value, whereby the camera can also automatically set an extent of the living sphere.

Moreover, the threshold distance used for defining the living sphere can also be adjusted according to the registered positional data. For instance, when the registered positional data are positional data pertaining to a home, the threshold distance is relatively increased, thereby spreading the living sphere. In contrast, when the registered positional data are positional data pertaining to a workplace, the threshold distance is relatively decreased, to thus reduce the living sphere. The technical idea of the present embodiment lies in that power consumption is reduced by halting operation of the GPS receiver 21 as long as possible in the area assumed to be well familiar to the user. Hence, the extent of the living sphere can be increasingly or decreasingly adjusted within a scope of the technical idea.

In the present embodiment, the image processing block 26 controls a receive cycle of the GPS receiver 21. However, needless to say, a processor separate from the image processing block 26 can also control the receive cycle.

The descriptions have been given in the embodiment by means of taking the digital camera as an example. However, the present invention can also be applied to any arbitrary portable equipment having a positioning device, like a portable phone and an information terminal.

### PARTS LIST

2 t_{POD}
11 diaphragm
12 lens
14 ccd
16 cds
18 amp
20 a/d
21 gps receiver
22 radio transceiver
23 timing generator
24 memory
26 image processing block
42 storage block
44 lcd
46 processing block
48 correction processing block
50 edge enhancement processing block
51 built-in battery
S101 start receiving data step
S102 acquire position step
S103 determine distance step
S104 determine position step
S105 calculate time increment step
S106 determine threshold step
S107 register position step
S108 double current parameter step
S109 compute parameter step
S110 determine value of parameter step
S111 stop receiving data step
S112 subtraction step
S113 resume receiving operation step
S114 reset parameter step
S115 reset cycle step

1. Portable device comprising:
positional data detection means;
registration means for registering positional data pertaining to a user's living sphere; and
control means that relatively increases a position detection interval of the positional data detection means when detected positional data correspond to the positional data pertaining to the living sphere than when the detected positional data do not correspond to the positional data pertaining to the living sphere.

2. The portable device according to claim 1, wherein the living sphere is a neighborhood of a position where a user stays for a given period of time or more.

3. The portable device according to claim 2, wherein the living sphere is a neighborhood of a user's home.

4. The portable device according to claim 1, wherein, when a change does not occur in the detected positional data for a given period of time or more, the registration means automatically registers the positional data as positional data pertaining to the living sphere.

5. The portable device according to claim 1, wherein, when the detected positional data correspond to the positional data pertaining to the living sphere, the control means sequentially increases the position detection interval according to a sojourn time.
